(19) United States
(12) Patent Application Publication
(10) Pub. No.: US 2007/0106710 A1
(43) Pub. Date: May 10, 2007

(54) Apparatus, system, and method for data migration

(76) Inventors: Nils Haustein, Zornheim (DE); Craig Anthony Klein, Tucson, AZ (US); Daniel James Winarski, Tucson, AZ (US)

Correspondence Address: KUNZLER & ASSOCIATES, 8 EAST BROADWAY, SUITE 600, SALT LAKE CITY, UT, 84111, US

(21) Appl. No.: 11/259,478

(22) Filed: Oct. 26, 2005

(51) Int. Cl. G06F 17/30

(52) U.S. Cl. 707/204

(57) ABSTRACT

An apparatus, system, and method are disclosed for data migration of retention data between data retention systems. The system includes a first back-end agent for accessing a first data retention system according to a first communication protocol, a first front-end agent for interfacing between the first back-end agent and the second front-end agent, and a second back-end agent for interfacing between the second front-end agent and the second data retention system according to a second communication protocol. The present invention described herein allows a user to migrate retained data from one retention data system to another while maintaining data attributes such as retention time.

### BACKGROUND OF THE INVENTION

1. Field of the Invention

This invention relates to data management systems and more particularly relates to a system and method for data migration of retention data between different types of data retention systems.

2. Description of the Related Art

Data storage systems provide cost effective storage and retrieval of large quantities of data. Data is placed on data storage media which may include magnetic media (such as magnetic tape or disks), optical media (such as optical tape or disks), electronic media (such as PROM, EEPROM, flash PROM, Compactflash TM, Smartmedia TM Memory Stick TM, etc.), or other suitable media.

Data storage systems often include data retention systems for storing data that should not be modified or deleted during a specified period of time, referred to herein as retention time. A data retention system assigns retention times generally to each data object placed into the data retention system. The data retention system monitors the retention times and manages the corresponding data objects to prevent the modification or deletion of the data objects prior to their retention times expiring. The process of creating data, retaining data, and allowing the data to be subsequently modified or deleted is referred to as an information lifecycle as illustrated in the block diagram of FIG. 1.

A traditional data management system 10 may include a client system 12, a document management system 14, a data retention system 16, and retention-data storage media 18 including retained data 20. The retention-data storage media 18 may include magnetic disk drives, optical disks (including magneto-optical disks, digital versatile disks, high-definition digital versatile disks, Blue-Ray disks, or holographic disks), magnetic tape, flash memory, and the like. Additional data storage media 28 may be accessed by the document management system 14 outside the control of the data retention system 16. Data on the data storage media 28 may comprise non-retained data 22.

The client system 12 typically generates data and information which may or may not need to be retained for a specified period of time. An exemplary client system 12 may include a front end application, an automated paper scan solution, a database, an electronic file-system, or interactive web sites wherein data may be generated, viewed, and updated.

The client system 12 may transmit the generated data to the document management system 14 which, in turn, may generate indices for use in searching the data by content or context. If the data arriving from the client system 12 is to be retained, i.e., to be stored for a period of time without revision or deletion, then the document management system 14 passes the data to the data retention management system 14, otherwise the data is placed into alternative data storage media 28 as non-retained data 22.

The data retention system 16 determines an appropriate retention time for each datum arriving from the document management system 14 and assigns the retention time as metadata for the datum within the meta data object 30. As illustrated here, a retention time meta data object 30 comprising a retained datum 32 is placed into the retention-data storage media 18. The data retention system 16 prevents modification or deletion of the retained datum 32 until the retention time 34 expires.

Upon expiration of the retention time, the data retention system 16 may immediately delete the corresponding retained datum 32 or may change its status to deletable, allowing the retained datum 32 to be deleted by an extrinsic application such as the client system 12. Alternatively, the data retention management system 16 may delete deletable data as storage locations are needed for additional retained data 20. Upon deletion of the retained datum 32 the retention time meta data object 30 will also be deleted.

The data retention management system 10 may utilize one of varied methods for establishing a retention time for each retained datum 32. One method creates a retention time in response to an event, such as a change in system status. Another triggering event may include the issuance, by the client system 12, of an instruction to assign or update a retention time. In response, the data retention system 16 will update the retention time data object 30 with the desired retention time. If the retention time associated with the triggering event has already expired, the data retention system 16 modifies the targeted datum's retention time value. In this way, a client system 12 may utilize a retention-time modification command to delete a retained datum 32 or make the retained datum 32 deletable. Multiple regulatory requirements may require that the retention time not be decreased. Therefore the data retention system 16 may not allow the retention time meta data object 30 to have a retention time smaller than the retention time before the request for an update.

It is sometimes desirable to transfer retained data 20 from one data retention system 16 to another. Such a data transfer may be necessitated by a desire to archive retained data 20, to duplicate retained data 20, or to transfer the retained data 20 to a different type or more modem data management system or data retention management system. FIG. 2 illustrates a traditional data migration system 100.

A traditional data migration system 100 typically includes one or more switches 102 which may form a switching fabric 104. Here, the data migration system 100 may utilize the Small Computer Systems Interface (SCSI) protocol running over a Fibre Channel (“FC”) physical layer. However, the data migration system 100 may utilize other protocols, such as Infiniband, FICON, TCP/IP, Ethernet, Gigabit Ethernet, or iSCSI or the like. The switch 102 contains the addresses to one or more host computers 106 and data retention systems 108,110.

As illustrated here, the host computer 106 connects to the fabric 104 utilizing an I/O interface 112. This I/O interface 112 may include a fibre-channel (“FC”) loop or one or more direct connection signal lines. The I/O interface 112 transfers information to and from the switching fabric 104.

The switching fabric 104 interconnects the host computer 106 to data retention systems 108,110 across I/O interfaces 114,116. These I/O interfaces may also include Fibre Channel, Infiniband, Gigabit Ethernet, Ethernet, TCP/IP, iSCSI, SCSI, or one or more direct-connection signal lines.

In this traditional data migration system 100, a host application 118 running on the host computer 106 may initiate a transfer of retained data 120 from the first data retention system 108 to the second data retention system 110. However, this traditional process of migrating retained data requires an extensive allocation of processing and communication resources. For example, the host application 118 utilizes the processing resources of its host computer 106 to create and issue commands which are carried by the switching fabric 104 to the first data retention management system 108 for retrieving the retained data 120. The retrieved data 120 is then passed through the switching fabric 104 to the host computer 106 where the retrieved data 120 is repackaged and transmitted to the second retention data management system 110 via the same switching fabric 104.

Because the host application 118 is tasked with managing this data migration process, a significant amount of the host computer's processing resources maybe allocated to the task. Likewise, because the host application's instructions, the retrieved data, and the retransmitted data all pass through the switching fabric 104, the communication bandwidth available for other processes may be substantially limited. Accordingly, it is desirable to have a system and method for migrating retained data between two or more data retention systems that reduces the utilization of the host computer's processing capacity and reduces the demand on the switching fabric's communication bandwidth.

Another problem of a traditional data-migration system 100 is that once the retained data 120 has been copied from the first data retention system 108 to the second data retention system 110, it may not be possible to delete the retained data 120 from the first data retention system 108. This problem may occur because the retention time associated with the retained data within the first data retention system 110 has not yet expired. This situation requires that the host application 118 issues additional commands to modify the retention time of the retained data residing in the first data retention system 108. It may be desirable however to prevent a decrease of the retention time. Accordingly, it is desirable to have a system and method for migrating retained data that allows the original retained data to be deleted without requiring additional instruction from the host application 118.

Yet another problem may occur if the first data retention system 108 and the second data retention system 110 from different manufacturers. For example, if the first data retention system 108 comprises an IBM DR550®, an event or command from the host application 118 may create retention times by class within the first data retention system 108. Additionally, once a retention time has expired, the corresponding retained datum may be automatically deleted. However, the second data retention system 110 may be a data retention system other than an IBM DR550.

In this second data retention system 110, which utilizes content-addressable storage, a retention time is issued to the second data retention system 110 from the host application 118 along with its associated datum. Additionally, when a datum's retention time has expired, this second data retention system 110 may not automatically delete the datum but rather allow it to be deleted in response to a command issued from the host application 118. Because of the differences between these two types of data retention system, migration of retained data from the first data retention system 108 to the second data retention system 110 may be difficult.

Accordingly, the host application 118 typically is written with sufficient sophistication to (a) ascertain the first data retention system type, (b) retrieve retained data 120 from the first data retention system 108, (c) determine the balance of each retention time associated with each datum, (d) ascertain the second data retention system type, (e) calculate new retention times, (f) copy the retained data to the second data retention system 110, and (g) issue the new retention times in the manner required by the second data retention system 110. This daunting task is complicated by the requirement that the first and second data retention systems must have synchronized clocks. Otherwise, an appropriate time differential must be calculated by the host application 118.

From the foregoing discussion, it should be apparent that a need exists for an apparatus, system, and method that supervises and facilitates the migration of retained data between different types of data retention systems without the supervision of a host application.

### SUMMARY OF THE INVENTION

The present invention has been developed in response to the present state of the art, and in particular, in response to the problems and needs in the art that have not yet been fully solved by currently available data migration systems. Accordingly, the present invention has been developed to provide an apparatus, system, and method for migrating retained data between data retention systems that overcome many or all of the above-discussed shortcomings in the art.

The apparatus, in one embodiment, is configured to receive a copy of retained data according to a common data retention protocol, to store the copy of retained data to a data storage medium according to a second data retention protocol, and to store a retention time according to the second data retention protocol, independent of an external application.

In a further embodiment, the apparatus may be configured to acknowledge that a successful data migration procedure has occurred, allowing the original retained data to be deleted from the first data retention system.

A system of the present invention is also presented to create a copy of retained data from a first data retention system according to a first data retention protocol, to transmit the copy of retained data to a second data retention system, to receive the copy of retained data at the second data retention system according to a second data retention protocol, to generate a retention time for the copy of the retained data, and to store the copy of the retained data and the generated retention time in the second data retention system. In particular, the system, in one embodiment, may perform this data migration procedure independent of external applications.

The system may further be configured to acknowledge that a successful data migration procedure has occurred, allowing the original retained data to be deleted from the first data retention system.

A method of the present invention is also presented for migrating retained data. The method in the disclosed embodiments substantially includes the steps necessary to carry out the functions presented above with respect to the operation of the described apparatus and system. In one embodiment, the method includes creating a copy of retained data within a first data retention device, translating the copy of the retained data according to a common protocol, transmitting the data to a second data retention device, translating the received data according to a protocol corresponding to the second data retention device, producing a data retention time relevant to the second data retention system, and storing the copy of retained data and its retention time in the second data retention system. The method also may include acknowledgement that the migration of retained data has been successful.

In a further embodiment, the method includes deletion of the original retained data in the first data retention system.

Reference throughout this specification to features, advantages, or similar language does not imply that all of the features and advantages that may be realized with the present invention should be or are in any single embodiment of the present invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the present invention may be combined in any suitable manner in one or more embodiments. One skilled in the relevant art will recognize that the present invention may be practiced without one or more of the specific features or advantages of a particular embodiment. In other instances, additional features and advantages may be recognized in certain embodiments that may not be present in all embodiments of the present invention.

These features and advantages of the present invention will become more fully apparent from the following description and appended claims, or may be learned by the practice of the present invention as set forth hereinafter.

### BRIEF DESCRIPTION OF THE DRAWINGS

In order that the advantages of the present invention will be readily understood, a more particular description of the present invention briefly described above will be rendered by reference to specific embodiments that are illustrated in the appended drawings. Understanding that these drawings depict only typical embodiments of the present invention and are not therefore to be considered to be limiting of its scope, the present invention will be described and explained with additional specificity and detail through the use of the accompanying drawings, in which:

FIG. 1 is a block diagram illustrating a traditional data management system including a data retention system;

FIG. 2 is a block diagram illustrating a traditional data migration system including disparate types of data retention systems;

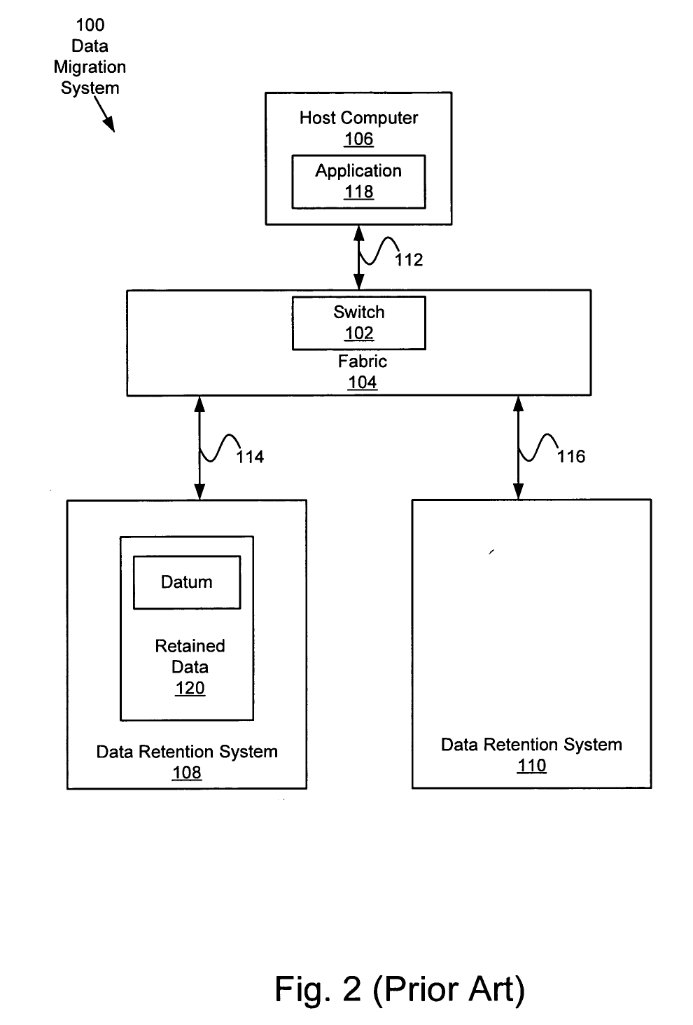

FIG. 3 is a block diagram illustrating aspects of an exemplary data migration system utilizing a communication network, according to one embodiment of the present invention;

FIG. 4 is a block diagram illustrating aspects of an exemplary data migration system utilizing a switching fabric, according to one embodiment of the present invention;

FIG. 5 is a block diagram illustrating aspects of an exemplary data migration system utilizing data migration I/O interfaces, according to yet another embodiment of the present invention;

FIG. 6 is a block diagram illustrating aspects of an exemplary data migration system utilizing a common data migration I/O interface according to still another embodiment of the present invention;

FIG. 7 is a block diagram illustrating aspects of an exemplary data migration system utilizing a common data migration manager, according to one embodiment of the present invention;

FIG. 8 is a flow chart illustrating a process for migrating retained data, according to one embodiment of the present invention; and

FIG. 9 is a block diagram illustrating a process for migrating retained data, according to one embodiment of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the present invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the present invention. One skilled in the relevant art will recognize, however, that the present invention maybe practiced without one or more of the specific details, or with other methods, components, materials, and so forth. In other instances, well-known structures, materials, or operations are not shown or described in detail to avoid obscuring aspects of the present invention.

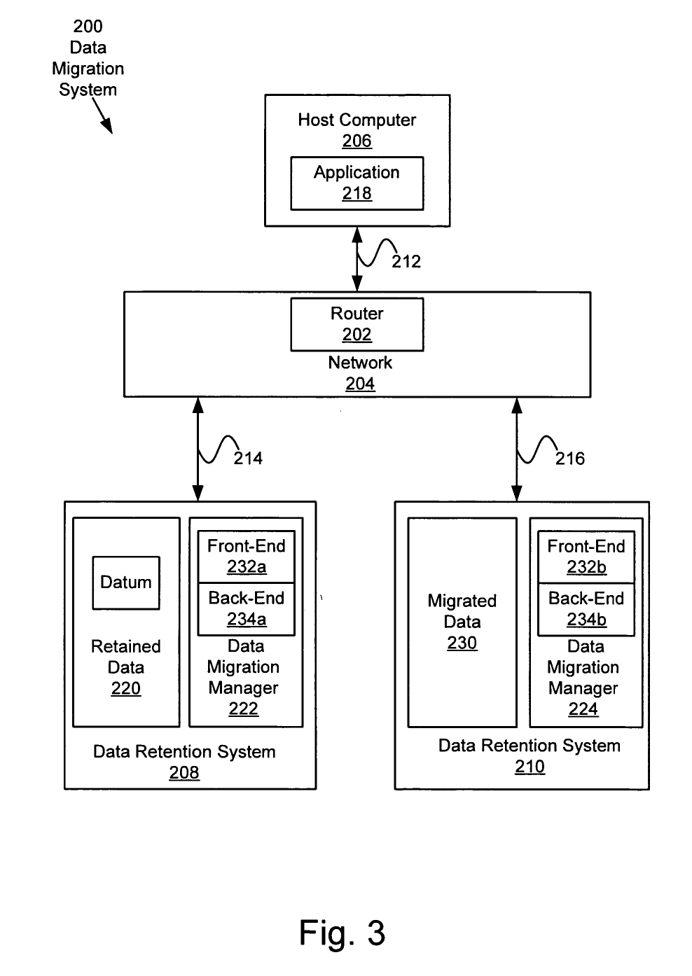

Referring to the figures, wherein like parts are designated with the same reference numerals and symbols, FIG. 3 is a block diagram that illustrates aspects of an exemplary data migration system 200, according to one embodiment of the present invention. The data migration system 200 is connected to a local area network, wherein a communication network 204 includes one or more conventional routers 202 and may be based on the TCP/IP protocol. The conventional router(s) 202 contain the addresses of one or more host computers 206, a first data retention system 208, and a second data retention system 210.

The host computer 206 is connected to the communication network 204 utilizing a host I/O interface 212. The communication network 204 is, in turn, connected to the first data retention system 208 through a first data-retention I/O interface 214 and to the second data retention system 210 through a second data-retention I/O interface 216. These data-retention I/O interfaces are utilized by the host computer 206 to store, retrieve, query and delete data objects.

A host application 218 running on the host computer 206 may initiate a transfer of retained data 220 from the first data retention system 208 to the second data retention system 210. However, to do so obviates the need to utilize extensive processing capacity of the host computer 206 and reduces the communication bandwidth utilization of the communication network 204. In a preferred embodiment, the initiation of the transfer of retained data 220 is triggered within the first data retention system 208 or second data retention system 210 independent of the host system 206 or application 218.

A first and second data migration manager 222,224 create and issue commands for transferring the retained data 220 from the first data retention system 208 to the second data retention system 210. The first data migration manager 222,224 may pass retained data 220 to the communication network 204 via the first data-retention I/O interface 214 and to the second data retention system 210 via the second data-retention I/O Interface 216.

The data migration managers 222,224 are tasked with (a) sending and retrieving retained data 220 from the first data retention system 208 to the second data retention system 210, (b) determining the balance of each retention time associated with each datum, (c) calculating new retention times or adjusting copies of retention times defined for retained data 220, as needed, (d) copying the retained data to the second data retention system 210, (e) writing the new or adjusted retention times to the second data retention system 210, (f) performing integrity checks and error handling to ensure that the migrated data 230 has not been altered, and (g) producing an audit trail for use as proof of migration and data preservation in legal matters, medical records, or the like. Additionally, the first data migration manager 222 may be tasked with either deleting the retained data 220 on the first data retention system 208 or making the retained data 220 deletable.

Because the data migration managers 224,224 are tasked with managing the data migration process, a significant amount of the host computer's processing resources need not be allocated to the task. Likewise, because the host application 218 only issues an instruction to initiate the migration of retained data, the demand on the communication bandwidth of the communication network 204 is also reduced.

In this embodiment of the present invention, the first data retention system 208 and the second data retention system 210 are of different types from different manufacturers. For example, the first data retention system 208 may include an IBM DR550 while the second data retention system 210 may include an EMC Centera®. Those of skill in the art recognize that the first data retention system 208 and second data retention system 210 may be the same make and model and come from the same manufacturer.

The data migration managers 222,224 may each include a front-end agent 232a,232b and a back-end agent 234a,234b. The front-end agents facilitate the communication between the first and second data migration managers 222,224 through the first and second data-retention I/O interfaces 214,216 and the communication network 204. These front-end agents 232a,232b also interact with the associated back-end agents 234a,234b which, in turn, interface with the retained data 220,230 and may include application program interfaces (“APIs”).

One of the benefits of the present invention is that multiple front-end agents 232 may be standardized, even though each front end agent 232 is associated with a different type of data retention system 208, 210. However, each back-end agent 234a,234b utilizes a method unique to its respective data retention system 208, 210. As such, translation and unification of data migration tasks occur between the front-end agents and their respective back-end agents. Alternatively, the front-end agents translate data and commands utilizing a protocol associated with a source data retention system to those conforming to a protocol associated with the target data retention system. In yet another alternative, data and information may be translated between disparate protocols within the communication network 204.

The migration protocol embodied by the front-end agents 232a,232b may include the following command constructs including: (1) initiate migration process; (2) origin and destination negotiation; (3) send/receive migration data; (4) send/receive data object information; and (5) migration completion. The initiate migration process command may originate from the host application 218, the first data retention system 208, or the second data retention system 210. Origin and destination negotiation begins with the initiating device and includes the designated role of each device (source/target) and the name of the data object to be migrated. The receiving system can reject the negotiation request for varied reasons, such as the object name or object selection policy is invalid, the system has been disabled for migration, etc.

The retained-data 220 is transferred in response to the send/receive migration data command and the object information is transmitted and received in response to the send/receive data object information command. The object information may include (a) object size, (b) checksum, (c) retention time, (d) data location, (e) type of object, (f) owner/user information, (g) access control information, and (h) object description, etc. The migration completion command informs the front-end agents 232a,232b that a data migration has completed and is sent when (a) the destination agent has received the data and object information, (b) the destination agent has checked the checksum, and (c) the data object and object information have been successfully stored.

The role of the back-end agents 234a,234b is to interface each front end agent 232a,232b according to the protocol associated with each data retention system 208,210. The command structure of each protocol may vary from one type of data retention system to another. However, whichever protocol a data retention system may utilize, all data and attributes of the data retention system are preferably available to a back-end agents' 234a,234b associated front-end agent.

Accordingly, the back-end agents 234a,234b include the ability to: (1) query information items of an object managed by the data retention system including object size, data checksum, retention time, storage location, type of object, ownership/user information, access control attributes, and description, etc.; (2) obtain/read data objects; (3) store/write data objects; (4) set data object information; and (5) delete data objects. Depending on the type of data retention system associated with a particular back-end agent 234a,234b, some of these functions may not be available. In those instances, the back-end agent 234a,234b provides a default value for each missing attribute, such as “NULL.”

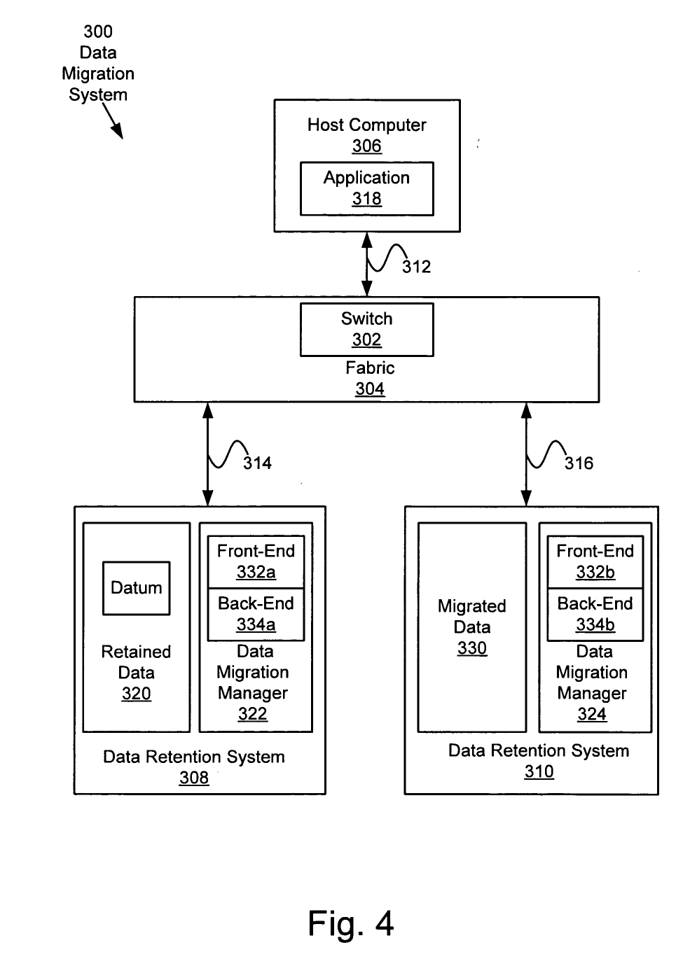

FIG. 4 is an alternate embodiment of a data migration system 300 designed as a switched-access-network, wherein switches 302 are utilized to create a switching fabric 304. In this embodiment of the present invention, the data migration system 300 is implemented using Small Computer Systems Interface (SCSI) protocol running over a Fibre Channel (“FC”) physical layer. However, the data migration system 300 could be implemented utilizing other protocols, such as Infiniband, FICON, iSCSI, or the like. The switches 302 contain the addresses of one or more host computers 306, a first data retention system 308, and a second data retention system 310.

The host computer 306 is connected to the switching fabric 304 utilizing a host I/O interface 312. This host I/O interface 312 may include an FC loop, a direct connection, or one or more signal lines to transfer information to and from the switching fabric 304. Switch 302 interconnects the switching fabric 304 to the first data retention system 308 through a first data-retention I/O interface 314 and to the second data retention system 310 through a second data-retention I/O interface 316. These data-retention I/O interfaces may include Fibre Channel, Infiniband, iSCSI, SCSI, one or more signal lines, or other appropriate communication channels. These data-retention I/O interfaces are utilized by the host computer 306 to store, retrieve, query and delete data objects.

In this embodiment of the present invention, a host application 318 running on the host computer 306 initiates a transfer of retained data 320 from the first data retention system 308 to the second data retention system 310. One or more data migration managers 322,324 create and issue the commands for transferring the retained data 320 from the first data retention system 308 to the second data retention system 310. Retrieved data is passed to the switching fabric 304 via the first data-retention I/O interface 314 and to the second data retention system 310 via the second data-retention I/O Interface 316.

The data migration managers 322,324 each include a front-end agent 332a,332b and a back-end agent 334a,334b. The front-end agents facilitate the communication between the first and second data migration managers 322,324 through the first and second data retention I/O interfaces 326,328 and the switching fabric 304. These front-end agents also interact with the back-end agents 334a,334b. These back-end agents, in turn, interface with the retained data 320,330 and may include application program interfaces (“APIs”).

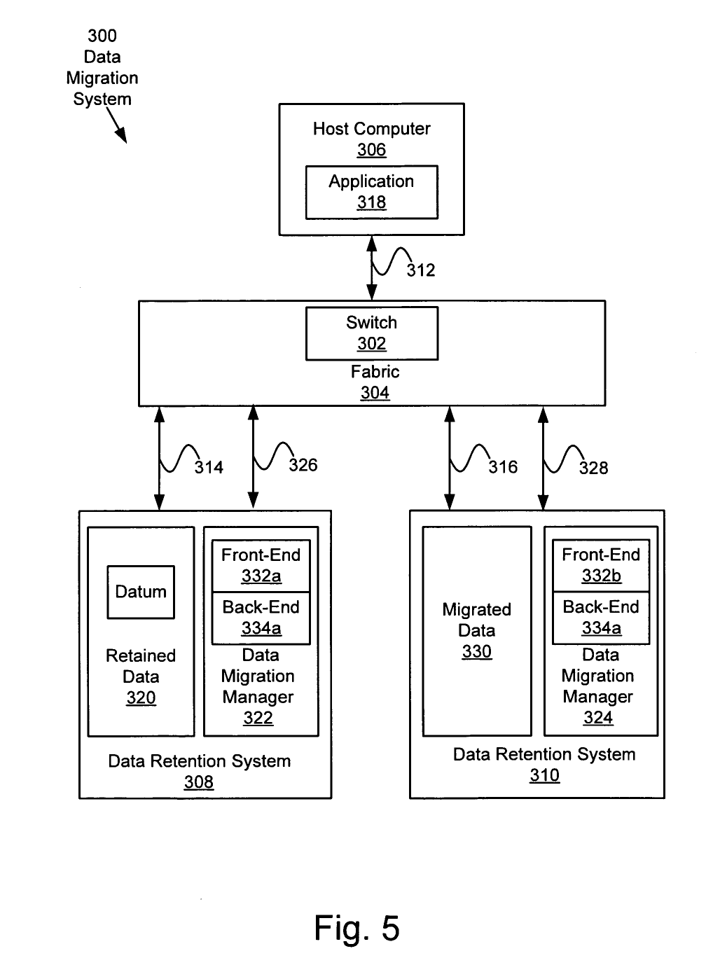

FIG. 5 is an illustration of yet another embodiment of a data migration system 300 similar to that illustrated by the block diagram of FIG. 4. However, in this embodiment of the present invention, retrieved data is passed to the switching fabric 304 via a first data-migration I/O interface 326 and to the second data retention system 310 via a second data-migration I/O Interface 328. In this manner, the data-retention I/O interfaces 314,316 may be dedicated to tasks other than retained-data migration. Advantageously, the I/O interfaces for data migration 326, 328 are separated from the host interfaces 314, 316 allowing better bandwidth and performance for normal data transfer via the host interfaces 314, 316 and data migration transfer via interfaces 326, 328. These data-migration I/O interfaces 326,328 may also include Fibre Channel, Infiniband, iSCSI, SCSI, one or more signal lines, or other appropriate communication channels.

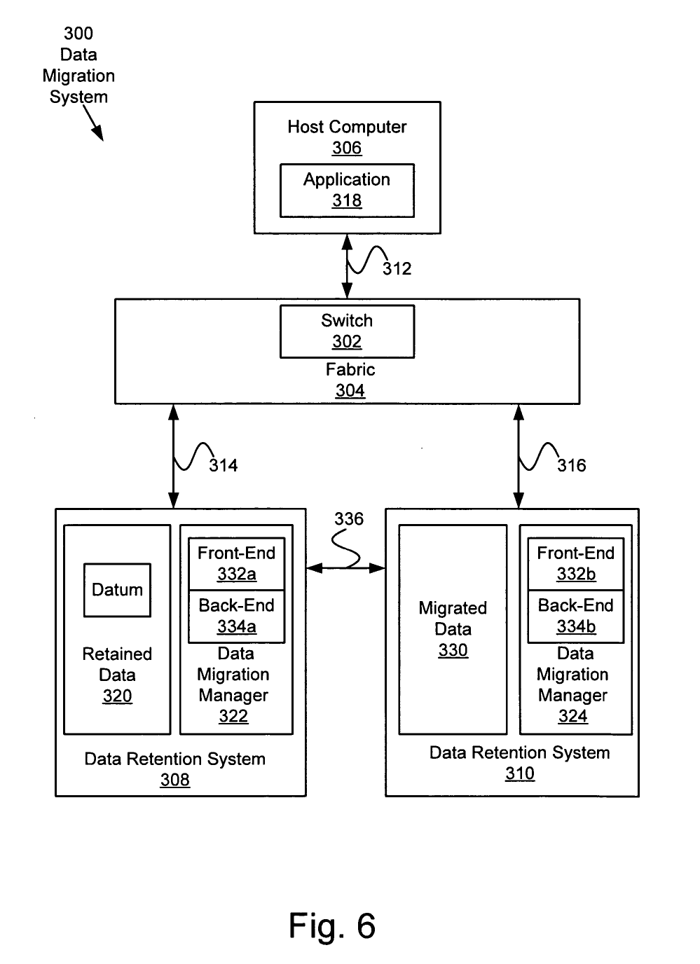

The block diagram of FIG. 6 illustrates still another embodiment of the present invention, similar to that illustrated by FIG. 5. However, the first and second data migration I/O interfaces 326,328 have been replaced by a common data migration I/O interface 336 which connects the first front-end agent 332a directly to the second front-end agent 332b. In this manner, copied retained data need not pass through the switching fabric 304, thus reducing the demand on the communication bandwidth of the switching fabric 304. Thus the normal data transfer via I/O interface 314, 316 is totally separated from the data migration transfer via interface 326.

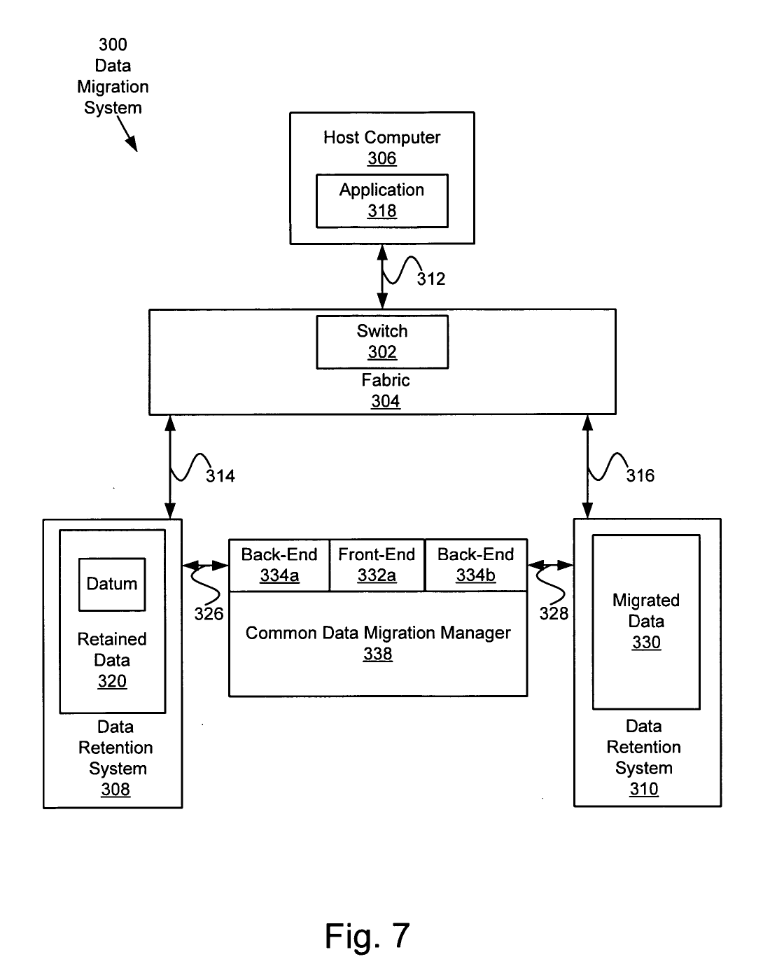

The block diagram of FIG. 7 illustrates yet one more embodiment of the present invention wherein a common data migration manager 338 includes a first back-end agent 334a connected to the first data retention system 308 via the first data migration I/O interface 326, a common front-end agent 332, and a second back-end agent 334b connected to the second data retention system 310 via the second data migration I/O interface 328. Each back-end agent 334a,334b is still tasked with interfacing with its respective data retention system 308, 310 while the common front-end agent 332 facilitates communication between each back-end agent 334a,334b.

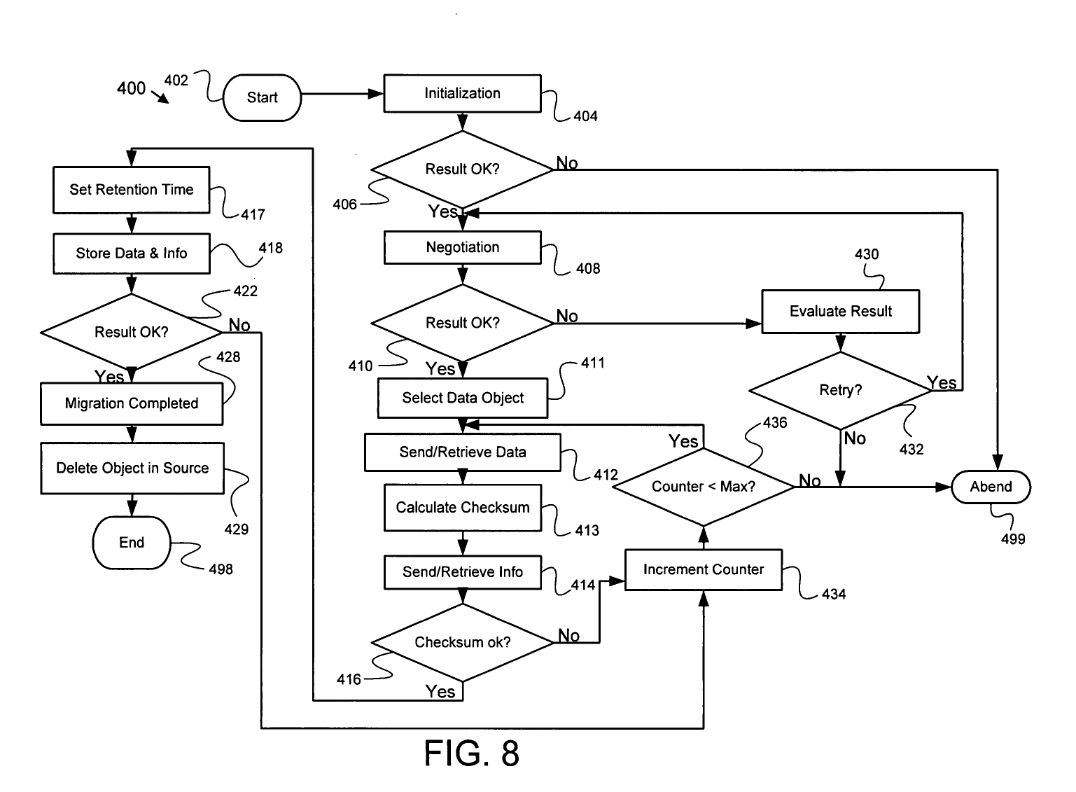

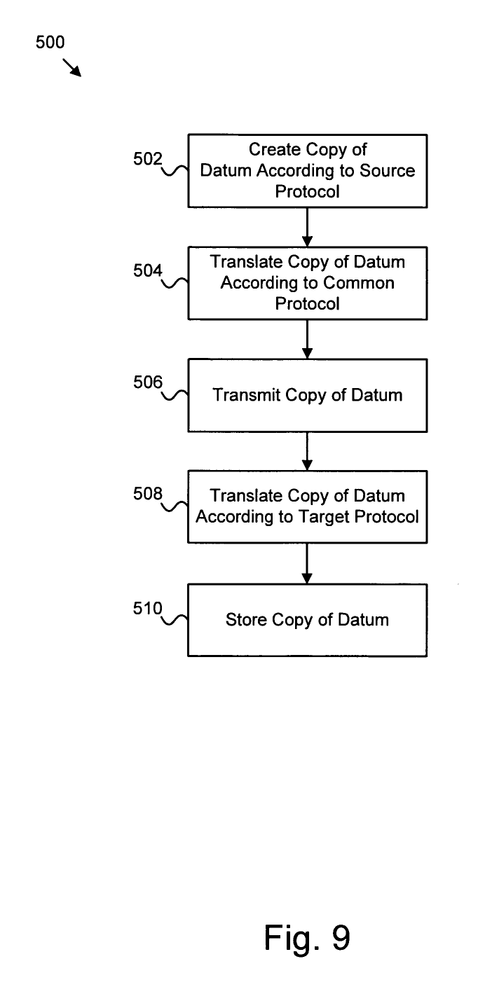

Methods of migrating retained data, according to the present invention, are exemplified by the flowchart 400 of FIG. 8 and the block diagram of FIG. 9. These algorithms define specific operations which may occur in a particular order. However, in alternative implementations, certain logic operations may be performed in a different order, may be modified or may be removed. Moreover, operations may be added to the above described logic and still conform to the described implementations. Operations described herein may occur sequentially or may be processed in parallel. Additionally, operations described as performed by a single process may be performed by distributed processes. These algorithms may be part of the operating system of the host system 306 or an application program, such as host application 318 (FIGS. 3-7) or the first data retention system 308 or second 310 data retention system. The combination of host application 318 and host system 306 are but one example of an article of manufacture.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Data migration typically involves a source system where the data is currently stored and a target system where the data is to be migrated. In the algorithm of FIG. 8 as illustrated by the flow chart 400, a data object residing in a source data retention system 308 (FIG. 5) is migrated to a target data retention system 310. In this embodiment, both data retention systems 308,310 include front end agents 332a,332b and backend agents 334a,334b and are in communication with each other through fabric 304. The migration process is described from the point of view of the target data retention system 310 which, in this instance, has initiated the migration of retained data from the source data retention system 308.

The migration method may begin 402 when the front end agent 334b of the target data retention system 310 initiates 404 the migration process by sending a migration initiation message to the front end agent 332a of the source data retention system. For clarity, those of ordinary skill in the art will recognize that the initiation need not originate with the target data retention system, but may also originate with the source date retention system 308 or an external process, such as the host application 318. In this example, the source data retention system 308 provides a response to the initiation message. The initiating front end agent 334b evaluates 406 this. If the source data retention system 308 rejects the migration initiation request, the method 400 ends 499. The rejection of a migration initiation message may occur because the source data retention system 308 may be currently disabled.

If the source data retention system 308 accepts the initiation request, the initiating front end agent 332b may send 408 a negotiation request to the front-end agent 332a of the source data retention system 308. The negotiation request instructs the source front end agent 332b of its role as source for this migration session. The target front-end agent 332b may also transmits the object selection policy denoting the objects to be migrated from the source front end agent 332a. An object selection policy may comprise a logical combination of one or more criteria and may describe how object names subject for migration are to be selected. Object selection may result in a list of one or more object names available for migration. The object selection policy is discussed below in more detail.

The target front-end agent 332b evaluates 410 the response of the source front-end agent 332a. If negative, the data migration manager 324 evaluates 430 a return code given by the source front-end agent 332a.

Next, the data migration manager 324 determines 432 whether to retry the negotiation or not based on the return code. One reason for a retry may be that the object selection policy resulted in the names of objects that have not been recognized by the source data migration manager 322. In this case, the target front-end agent 332b may attempt to retry the data migration process using a different object selection policy. If the determination 432 to retry is positive, the method 400 sends 408 another negotiation request. If the determination 432 is negative, the method 400 ends 499 in an error state.

If the target front-end agent 332b evaluates 410 the response to a positive result, the method 400 continues. Next, the source front-end 332a selects 411 data objects eligible for migration from the source data retention system 308. The source front-end 332a may data objects eligible for migration based on object selection policies incorporating different criteria which are explained below. Typically, the source front-end 332a generates a list containing the names of one or more objects to be migrated.

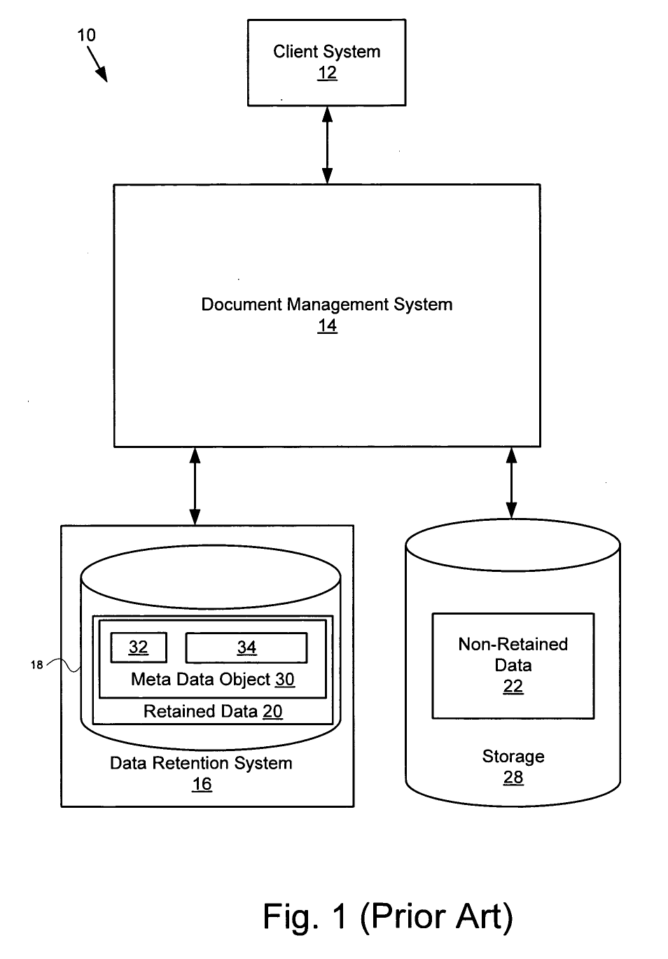

The front-end agent 332a of the source data retention system 308 instructs 412 the associated backend agent 334a to retrieve the selected data objects 32 (See FIG. 1) on the list. The front-end agent 332a sends 412 the selected data objects 32 to the front-end agent 334b of the target system 310 which receives the data objects 32.

Next, the front end agent 332a calculates 413 a checksum for the transferred data. Then, the front end agent 332a of the source system 308 instructs 414 the associated backend agent 334a to retrieve the metadata object retention information 30 such as retention time, checksum, storage location, owner, and the like. The front end agent 332a sends 414 the object retention information to the front end agent 332b of the target system 310. The target system front-end agent 332b compares 416 a calculated checksum to the transmitted checksum. If the checksums do not match, the target systems front-end agent 332b increments 434 a retry counter.

The target system front-end agent 332b compares 436 this counter with a maximum retry counter. If the retry counter is greater than the maximum retry counter, the method 400 ends 499 in an error state. Otherwise, the method 400 returns to retry sending 412 and retrieving 412 the data.

If the checksums match, the target system front-end agent 332b calculates and sets 417 a remaining retention time. The remaining retention time becomes the new retention time within the target data retention system 310. The remaining retention time may be calculated by the mathematical difference between the total retention time assigned to the object when it was stored minus the already expired retention time.

Next, the target front-end agent 332b instructs its associated back-end agent 334b to store 418 both the data object 32 and the metadata object information 30. More precisely, the backend agent 332b may store the data, apply the retention time, and other object information for the just migrated object in the target system 310. The backend agent 332b evaluates 422 the result of the storage operation. If the result is valid, the backend agent 332b sends 428 a migration completion message to the source front-end agent 332a. Upon reception of this message, the source front-end agent 332a may instruct 429 its back-end agent 334a to delete the original retained data and the process ends 498 successfully. If the storage operation fails, the method 400 returns to increment 434 a retry counter.

In one embodiment, the operations of method 400 are performed for each selected data objects separately. In an alternate embodiment, the method 400 is executed for all selected object together.

This illustrative process facilitates the provision of an audit trail by logging each operation as performed. In one embodiment, the data migration manager 322, 324 includes a logger (not shown) configured to log the progress of migrating each data object 32 and metadata object information 30. This audit trail maybe retained in a non-rewriteable and non-erasable media in one or both data retention systems 308,310 for example by storing the associated information on optical WORM medium such as CD or DVD.

The migration process 400 may be triggered by one of a plurality of different means: (1) the initiation of the migration may be based on a user-configurable schedule within the source data retention time 308 or target 310 data retention system; (2) the migration may triggered by a user from the host system 306 or application 318 or from the source- 308 or target 310 data retention system; (3) the migration process may be triggered by an external event, for example the obsolescence of the source data retention system 308 and the availability of a newer target data retention system 310.

The data objects eligible for migration are selected based on object selection policies explained above. The initiating front-end agent provides the object selection policy. The source front-end agent then produces a list of objects to be migrated. The selection policies may include one or a logical combination of more criterion and may be based on the following criteria: (a) age of the object, (b) date and time of archival, (c) objects residing on one logical or physical storage location, (d) name of the owner, (e) size of the object, (f) sorted list, (g) wild cards denoting parts of the object name, (h) date of expiration and (i) other retention parameters, such as the reception of an event or deletion hold. For example a selection policy may include all objects older than 2 years. A different policy may include all objects older than 2 years AND residing on a specific data storage medium. A logical storage location may be a volume or a file system, a physical storage location is a physical storage entity such as a tape, a disk or an optical medium.

The block diagram of FIG. 9 illustrates a process of migrating retained data. Initially, a source back-end agent 334a creates 502 a copy of a retained datum according to the protocol of the source data retention system 308. The protocol of the source system 308 is based on the implementation of the data retention system and may vary between different types of systems. An associated front-end agent 332a translates 504 the copied datum according to a common protocol. The common protocol unifies different data retention systems via the front end agents 332a, 332b. The copy of the datum 32 is then transmitted 506 to a target front-end agent 332b. The target back-end agent 334b translates 508 the received datum 32 according to the protocol of the target data retention system 310 and then stores 510 the datum. Preferably, the metadata retention information 30 such as the retention time, owner, checksum and storage location is stored with the datum.

The present invention may be embodied in other specific forms without departing from its spirit or essential characteristics. The described embodiments are to be considered in all respects only as illustrative and not restrictive. The scope of the present invention is, therefore, indicated by the appended claims rather than by the foregoing description. All changes which come within the meaning and range of equivalency of the claims are to be embraced within their scope.

What is claimed is:

1. A data migration system, comprising:
a first data retention device having a first storage medium having original retained data;
a second data retention device having a second storage medium; and
a data migration manager in communication with the first data retention device and the second data retention device wherein the data migration manager is adapted to create a copy of said original retained data, to transmit said copy of said original retained data to said second data retention device, to receive said copy of said original retained data, to store said copy of said original retained data on said second storage medium, to store a retention time corresponding to said copy of original retained data on said second storage medium, and to facilitate deletion of the original retained data from the first data retention device.

2. The data migration system of claim 1 wherein the data migration manager includes a first component in communication with said first data retention device and wherein the first component is adapted to translate said copy of said original retained data according to a common data retention protocol prior to said data migration manager transmitting said copy of said original retained data to said second data retention device, independent of an external application.

3. The data migration system of claim 2 wherein the data migration manager includes a second component in communication with said second data retention device and wherein the second component is adapted to translate said copy of said original retained data according to a first data retention protocol prior to said data migration manager storing said copy of said original retained data on said second storage medium and wherein the second component is further adapted to transmit an acknowledgment of a successful data migration to the first component.

4. The data migration system of claim 3, wherein the first component includes a first back-end agent adapted to access the first data retention system according to a second data retention protocol.

5. The data migration system of claim 4, wherein the first component includes a first front-end agent adapted to interface between said first back-end agent and said second component.

6. The data migration system of claim 5, wherein the second component includes a second back-end agent adapted to access the second data retention system according to the first data retention protocol and further wherein the second component includes a second front-end agent adapted to interface between said first front-end agent and said second back-end agent.

7. A data retention device, comprising:
a storage medium; and
a data migration manager adapted to receive a first copy of original retained data from a second data retention device according to a common data retention protocol, to store the first copy of original retained data to said storage medium according to a second data retention protocol, and to store a first retention time to said storage medium according to said second data retention protocol.

8. The first data retention device of claim 7, wherein the data migration manager is further adapted to transmit a second copy of original retained data according to said common data retention protocol.

9. The data retention device of claim 7 wherein the data migration manager includes a front-end agent adapted to receive the first copy of original retained data according to the common data retention protocol.

10. The data retention device of claim 9, wherein the data migration manager includes a back-end agent adapted to interface the front-end agent according to the common data retention protocol and the data storage medium according to the second data retention protocol.

11. The data retention device of claim 10, wherein the data migration manager is adapted to receive the retention time prior to storing the retention time to the data storage medium.

12. A signal bearing medium tangibly embodying a program of machine-readable instructions executable by a digital processing apparatus to perform operations
creating a copy of original retained data having a first retention time residing within a first data storage device included in a source data retention device according to a first data retention protocol;
transmitting the copy of original retained data and the first retention time to a target data retention device;
creating a second retention time according to a second data retention protocol, the second retention time corresponding to the first retention time;
storing the copy of original retained data to a second data storage device within the target data retention device according to the second data retention protocol; and
storing the second retention time to the second data storage medium.

13. The article of manufacture of claim 12, further comprising translating the copy of an original retained data according to a common data retention protocol prior to transmitting the copy of original retained data and the first retention time to the target data retention device.

14. The article of manufacture of claim 13, further comprising translating the copy of original retained data according to the second data retention protocol prior to storing the copy of original retained data.

15. The article of manufacture of claim 12, further comprising transmitting an acknowledgment of a successful data migration from the target data retention device to the source data retention device.

16. The article of manufacture of claim 12, further comprising deleting the original retained data.

17. A method of providing a service for migrating retained data, comprising integrating computer-readable code into a computing system, wherein the computer-readable code in combination with the computing system is capable of performing the following operations:
creating a copy of original retained data having a first retention time residing within a first data storage device included in a source data retention device according to a first data retention protocol;
transmitting the copy of original retained data and the first retention time to a target data retention device;
creating a second retention time according to a second data retention protocol;
storing the copy of original retained data to a second data storage device within the target data retention device according to the second data retention protocol; and
storing the second retention time to the second data storage medium.

18. The method of claim 17, further comprising translating the copy of original retained data according to a common data retention protocol prior to transmitting the copy of original retained data and the first retention time to the target data retention device.

19. The method of claim 17, further comprising translating the copy of original retained data according to the second data retention protocol prior to storing the copy of original retained data.

20. The method of claim 17, further comprising transmitting an acknowledgment of a successful data migration from the target data retention device to the source data retention device.
